(19) United States
(12) Patent Application Publication
(10) Pub. No.: US 2025/0391910 A1
(43) Pub. Date: Dec. 25, 2025

(54) SOLID ELECTROLYTE, PREPARATION METHOD THEREOF AND ALL-SOLID-STATE RECHARGEABLE BATTERIES

(71) Applicants: SAMSUNG SDI CO., LTD., Yongin-si, Gyeonggi-do (KR); UIF (UNIVERSITY INDUSTRY FOUNDATION), YONSEI UNIVERSITY, Seoul (KR)

(72) Inventors: Yoon Seok JUNG, Seoul (KR); Youngsoo KIM, Yongin-si, Gyeonggi-do (KR); Kyu Tae KIM, Seoul (KR); Jehoon WOO, Seoul (KR); Sihyeon SUNG, Yongin-si, Gyeonggi-do (KR); Kookhan KIM, Yongin-si, Gyeonggi-do (KR); Jinhwan PARK, Yongin-si, Gyeonggi-do (KR)

(73) Assignees: SAMSUNG SDI CO., LTD., Yongin-si, Gyeonggi-do (KR); UIF (UNIVERSITY INDUSTRY FOUNDATION), YONSEI UNIVERSITY, Seoul (KR)

(21) Appl. No.: 18/879,684

(22) PCT Filed: Jan. 9, 2024
(86) PCT No.: PCT/KR2024/000409

§ 371 Date: Dec. 27, 2024

(30) Foreign Application Priority Data
Mar. 31, 2023 (KR) 10-2023-0043192

(51) Int. Cl. H01M 10/056; H01M 10/0525

(52) U.S. Cl. CPC H01M 10/056; H01M 10/0525; H01M 2300/0071; H01M 2300/008; H01M 2300/0082

(57) ABSTRACT

Disclosed are a solid electrolyte, a preparation method thereof, and an all-solid-state rechargeable battery including the same, the solid electrolyte including solid electrolyte particles, and a coating layer on the surface of the solid electrolyte particles, wherein the coating layer includes a thermal decomposition product of a linear polysiloxane-based hydrophobic polymer, and the coating layer has a thickness of 1 nm to 50 nm.

### TECHNICAL FIELD

Solid electrolytes, preparation methods thereof, and all-solid-state rechargeable batteries are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries, and can reduce the thickness of the negative electrode, improving high-rate charging and discharging performance, and realizing high-voltage driving and high energy density.

Inorganic solid electrolytes such as sulfide, oxide, and halide are widely used as solid electrolytes. Inorganic solid electrolytes are considered key solid electrolyte materials because they have high ionic conductivity and easy formation of interparticle contact surfaces due to their soft mechanical properties. However, inorganic solid electrolytes are known to deteriorate due to their poor chemical stability, reacting with moisture in the air to form compounds such as hydrogen sulfide and hydrogen chloride.

In order to suppress the deterioration of the inorganic solid electrolyte, it is necessary to handle the materials in a specific space, such as a glove box with an inert gas atmosphere or a dry room from which moisture has been removed. However, this not only causes an increase in the process cost, but also has limitations in preventing continuous deterioration because the inorganic solid electrolyte reacts with a small amount of moisture in the space.

To solve this problem, research has been conducted to add metal oxide materials to inorganic solid electrolytes or to replace some of the elements with other elements to improve chemical stability and suppress deterioration due to reaction with moisture in the air. However, when adding a metal oxide material to an inorganic solid electrolyte, it is effective in suppressing the generation of hydrogen sulfide, etc., but not only does the ionic conductivity of the solid electrolyte decrease, but there is a limit to suppressing the deterioration of the solid electrolyte material itself. In addition, although it is effective in suppressing deterioration of the solid electrolyte material itself by replacing some of the elements in the inorganic solid electrolyte with other elements to suppress deterioration, there are limitations such as a decrease in the ionic conductivity of the solid electrolyte, the use of toxic elements such as arsenic, and limitations in the applicable structure.

Therefore, there is an urgent need to develop a technology that 1) can be applied to various inorganic solid electrolytes such as sulfide, oxide, and halide, 2) significantly reduces the decrease in ionic conductivity of the solid electrolyte, 3) is effective in suppressing deterioration of the solid electrolyte material itself, 4) does not use toxic elements, and 5) can be applied to materials of various structures.

### DISCLOSURE

A solid electrolyte is provided that improves atmospheric stability of an inorganic solid electrolyte, suppresses deterioration of the material itself, and reduces a decrease in ionic conductivity.

In an embodiment, a solid electrolyte includes solid electrolyte particles and a coating layer on the surface of the solid electrolyte particles, wherein the coating layer includes a thermal decomposition product of a linear polysiloxane-based hydrophobic polymer, and the coating layer has a thickness of 1 nm to 50 nm.

In another embodiment, a method for preparing a solid electrolyte includes introducing solid electrolyte particles and a linear polysiloxane-based hydrophobic polymer into a vacuum tube without contacting each other, and heat-treating the vacuum tube to vapor-deposit the linear polysiloxane-based hydrophobic polymer on the surface of the solid electrolyte particles.

In another embodiment, an all-solid-state rechargeable battery including the solid electrolyte is provided.

A solid electrolyte according to an embodiment of the present invention has excellent atmospheric stability and a small decrease in ionic conductivity, and thus an all-solid-state rechargeable battery using the solid electrolyte can implement excellent electrochemical characteristics such as cycle-life characteristics.

### DESCRIPTION OF THE DRAWINGS

FIGS. 1 and 2 are cross-sectional views schematically showing all-solid-state rechargeable batteries according to an embodiment.

FIG. 3 is an ultra-low temperature transmission electron microscope image of the surface of the solid electrolyte manufactured in Example 1.

FIG. 4 shows the results of X-ray photoelectron spectroscopy analysis of the solid electrolytes of Comparative Example 1 and Example 1.

FIG. 5 shows the results of thermogravimetric analysis for the solid electrolytes of Comparative Example 1 and Example 1.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Here, “or” is not to be construed as an exclusive meaning, for example, “A or B” is construed to include A, B, A+B, and the like.

“Metal” is interpreted as a concept including ordinary metals, transition metals and metalloids (semi-metals).

### Solid Electrolyte

In an embodiment, a solid electrolyte includes solid electrolyte particles and a coating layer on the surface of the solid electrolyte particles, wherein the coating layer includes a thermal decomposition product of a linear polysiloxane-based hydrophobic polymer, and the coating layer has a thickness of 1 nm to 50 nm. Here, the solid electrolyte particles correspond to a kind of core, and the final solid electrolyte may be a coated solid electrolyte.

### Coating Layer

In the solid electrolyte, the coating layer is formed by a type of vapor deposition method described later, and is different in composition and shape from those coated by general methods such as wet coating or dry coating. The coating layer may be formed, for example, by vacuum deposition. In a solid electrolyte prepared according to an embodiment, the coating layer is very thin with a thickness of 1 nm to 50 nm, and the thickness is very uniform, so that the thickness deviation is small. Accordingly, the solid electrolyte particles may be effectively prevented from coming into contact with moisture in the air, thereby fundamentally preventing deterioration of the solid electrolyte, and a degree to which the ionic conductivity of the solid electrolyte is reduced by the coating can be significantly reduced.

The coating layer may be in the form of a film that completely surrounds the surface of the solid electrolyte particles. In addition, the thickness of the coating layer is 1 nm to 50 nm, for example, 1 nm to 40 nm, 2 nm to 30 nm, 3 nm to 20 nm, 4 nm to 15 nm, or 5 nm to 10 nm. When the coating layer is formed with such a thin thickness, the decrease in ionic conductivity of the solid electrolyte due to the coating can be minimized, and the solid electrolyte particles can be fundamentally prevented from coming into contact with moisture in the air. Here, the thickness of the coating layer may be measured from an electron microscope image of a cross-section of the solid electrolyte, for example, by photographing a cross-section of the solid electrolyte cut by a focused ion beam (FIB) using a cryogenic transmission electron microscope (Cyro-TEM). Additionally, the thickness of the coating layer may be obtained by randomly measuring the thickness at 10 locations in an electron microscope image of a cross-section of a solid electrolyte and calculating the arithmetic average thereof.

The coating layer is characterized by having a uniform thickness. For example, a variation in the thickness of the coating layer in one solid electrolyte particle may be less than or equal to 30%, for example less than or equal to 25% or less than or equal to 20%. Here, the variation in the thickness of the coating layer may mean that, in an electron microscope image of a cross-section of a solid electrolyte, the thickness is measured at about 10 points on the surface of a single solid electrolyte particle, the arithmetic mean is calculated, and then the absolute value of the difference between one data and the arithmetic mean is divided by the arithmetic mean and multiplied by 100. As another example, the standard deviation of the coating layer thickness in one solid electrolyte particle may be less than or equal to 5 nm, for example less than or equal to 4 nm, less than or equal to 3 nm, or less than or equal to 2 nm. The standard deviation of the coating layer thickness can also be calculated by measuring the thickness at about 10 points in an electron microscope photograph. The variation or standard deviation of the thickness of the coating layer satisfying the above range means that a coating layer of uniform thickness is well formed in a film form on the surface of the solid electrolyte particles, and accordingly, the exposure of the solid electrolyte particles to the air is fundamentally blocked, thereby minimizing the decrease in lithium ionic conductivity due to the coating.

A content of the coating layer may be comprised in an amount of 1 wt % to 5 wt %, for example, 2 wt % to 5 wt % or 3 wt % to 5 wt % based on 100 wt % of the solid electrolyte. When the weight of the coating layer satisfies the above range, it is suitable for reducing the decrease in ionic conductivity while blocking the exposure of the solid electrolyte to air.

The coating layer is characterized in that the linear polysiloxane-based hydrophobic polymer includes a thermal decomposition product. In the vapor deposition process described later, the linear polysiloxane-based hydrophobic polymer undergoes thermal decomposition, and the thermal decomposition product of the polymer exists in the final coating layer. In the thermal decomposition product of the polymer, Si—O bonds, etc. can be detected. For example, in X-ray photoelectron spectroscopy (XPS) of a solid electrolyte according to an embodiment, Si—O peaks, etc. can be detected. For example, in the XPS analysis graph, a peak may appear at 102±0.1 eV, which is the position of Si—O 2p3/2, and a peak may appear at 102.6±0.1 eV, which is the position of Si—O 2p1/2.

The linear polysiloxane-based hydrophobic polymer refers to a polymer having a main chain centered on bonds between silicon and oxygen. In addition, the linear polysiloxane-based hydrophobic polymer is distinguished from polymers such as cyclic, branched, cross-linked, and network-type polymers, and is a polymer connected in the form of a single long chain. The linear polysiloxane-based hydrophobic polymer is most suitable for thinly and uniformly coating the surface of solid electrolyte particles by vapor deposition.

In addition, the polymer is hydrophobic, which means that it does not easily bind to water molecules, and can mean that the contact angle between any surface and a water droplet is greater than 90°. According to an embodiment, a solid electrolyte is coated with a thermal decomposition product of a hydrophobic polymer, so that the solid electrolyte particles can be effectively prevented from coming into contact with moisture in the air.

The linear polysiloxane-based hydrophobic polymer may be, for example, poly(dimethylsiloxane), poly(methylhydrosiloxane), poly(dimethylsiloxane-co-alkylmethylsiloxane), poly(dimethylsiloxane) having a terminal vinyl group, poly(dimethylsiloxane) having a terminal bis(hydroxylalkyl) group, poly(dimethylsiloxane) having a terminal bis(3-aminopropyl) group, poly(dimethylsiloxane) having a terminal hydroxyl group, or a combination thereof. Here, alkyl may be, for example, C1 to C10 alkyl, or C1 to C5 alkyl, or C2 to C5 alkyl. The C10 and other symbols indicate the number of carbon atoms, and C10 alkyl means alkyl having 10 carbon atoms.

Meanwhile, the linear polysiloxane-based hydrophobic polymer may contain a fluorine group. For example, the linear polysiloxane-based hydrophobic polymer may additionally include a C—F bond, in which case the hydrophobicity of the polymer is further enhanced, thereby more effectively blocking the solid electrolyte from contacting moisture in the air. The fluorine-containing polymers may be prepared by adding a material having a C—F bond into a linear polysiloxane-based hydrophobic polymer matrix through techniques such as crosslinking and grafting.

Specific examples of the linear polysiloxane-based superhydrophobic polymers including a fluorine group may include, but are not limited to, 1H,1H,2H,2H-perfluorodecyltriethoxysilane, 1H,1H,2H,2H-perfluorododecyltrichlorosilane, 1H,1H,2H-perfluorooctyltridecoxysilane, or a combination thereof.

A number average molecular weight of the linear polysiloxane-based hydrophobic polymer may be 3,000 g/mol to 50,000 g/mol, for example 5,000 g/mol to 50,000 g/mol, or 5,000 g/mol to 40,000 g/mol, or 10,000 g/mol to 30,000 g/mol. When the molecular weight of the polymer satisfies the above range, it is suitable for vapor deposition on the surface of solid electrolyte particles, can minimize the decrease in ionic conductivity of the solid electrolyte, and can improve the atmospheric stability of the solid electrolyte by reducing the degree of decrease in ionic conductivity of the solid electrolyte due to exposure to the atmosphere.

The coating layer may be amorphous (non-crystalline). By uniformly coating an amorphous coating layer including the thermal decomposition product of the linear polysiloxane-based hydrophobic polymer with a very thin thickness, the solid electrolyte particles can be effectively blocked from the atmosphere, while at the same time minimizing the decrease in ionic conductivity.

### Solid Electrolyte Particles

The solid electrolyte particles may include an inorganic solid electrolyte, for example, a sulfide-based solid electrolyte, an oxide-based solid electrolyte, a halide-based solid electrolyte, or a combination thereof. The aforementioned coating layer can be effectively deposited on the surface of various types of inorganic solid electrolyte particles.

Sulfide-based Solid Electrolyte The solid electrolyte particles may be, for example, sulfide-based solid electrolyte particles with excellent ionic conductivity. The sulfide-based solid electrolyte particles may include, for example Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂—LiₚMO_{q} (wherein p and q each an integer and M is P, Si, Ge, B, Al, Ga, or In), or a combination thereof.

The sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity may be prepared. Here, other components such as SiS₂, GeS₂, and B₂S₃ may be added to further improve the ionic conductivity.

Mechanical milling or solution method can be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a robust sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte may include argyrodite-type sulfide. The argyrodite-type sulfide may be represented by, for example, a chemical formula of LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl_{3.2}, Li_{6.2}PS_{5.2}Br_{0.8}, etc.

The sulfide-based solid electrolyte including such an argyrodite-type sulfide-based solid electrolyte may have high ionic conductivity close to the range of 10-4 to 10-2 S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including this can have improved battery performances such as rate capability, coulombic efficiency, and cycle-life characteristics.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

### Oxide-based Solid Electrolyte

The solid electrolyte particles may be oxide-based inorganic solid electrolyte particles and the oxide-based solid electrolyte may include for example Li₁₊ₓTi₂₋ₓAl(PO₄)₃ (LTAP) (0≤x≤4), Li_{1+x+y}AlₓTi₂₋ₓSi_{y}P_{3-y}O₁₂ (0≤x<2, 0≤y<3), BaTiO₃, Pb(Zr,Ti)O₃ (PZT), Pb₁₋ₓLaₓZr_{1-y}Ti_{y}O₃ (PLZT) (0≤x≤1, 0≤y≤1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0≤x≤2, 0≤y≤3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; and x is an integer of 1 to 10), or a mixture thereof.

### Halide-based Solid Electrolyte

The solid electrolyte particles may be a halide-based solid electrolyte.

The halide-based solid electrolyte contains a halogen element as a main component, meaning that a ratio of the halide element to all elements constituting the solid electrolyte may be greater than or equal to 50 mol %, greater than or equal to 70 mol %, greater than or equal to 90 mol %, or 100 mol %. For example, the halide-based solid electrolyte may not include a sulfur element.

The halide-based solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof and for example it may be Cl, Br, or a combination thereof. For example, the halide-based solid electrolyte may be represented by LiₐM¹_{c}M²ₐX_{b} (M¹ and M² are each independently Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, a and b are each independently in a range of 0.1 to 10, and c and d are each independently in a range of 0 to 1). For example, the halide-based solid electrolyte may include Li₂ZrCl₆, Li_{2.7}Y_{0.7}Zr_{0.3}C₁₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof, but is not limited thereto.

An average particle diameter (D50) of the solid electrolyte particles may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte particles may be small particles having a size of 0.1 μm to 1.5 μm, large particles having a size of 2.0 μm to 5.0 μm, or a mixture thereof. The average particle diameter of the solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

### Method for Preparing Solid Electrolyte

In an embodiment, a method for preparing a solid electrolyte includes introducing solid electrolyte particles and a linear polysiloxane-based hydrophobic polymer into a vacuum tube without contacting each other, heat-treating the vacuum tube to vapor-deposit the linear polysiloxane-based hydrophobic polymer on the surface of the solid electrolyte particles.

Through the above method, the thermal decomposition product of the linear polysiloxane-based hydrophobic polymer can be coated on the surface of the solid electrolyte particles in a very uniform and thin thickness. A method for preparing a solid electrolyte according to an embodiment of the present invention can suppress deterioration of the solid electrolyte that occurs during the coating process because it does not use a solvent, and can form a very thin and uniform coating layer, thereby minimizing the decrease in lithium ionic conductivity of the solid electrolyte. In addition, according to the above preparing method, it is possible to obtain a solid electrolyte in a powder state after coating, which is economical and simple and is more advantageous in suppressing deterioration of the solid electrolyte.

Because the solid electrolyte particles and the linear polysiloxane-based hydrophobic polymer themselves have been described above, a detailed description thereof is omitted. When these are introduced into a vacuum tube, the solid electrolyte particles and the linear polysiloxane-based hydrophobic polymer may be introduced at a weight ratio of 95:5 to 40:60, for example, at a weight ratio of 91:9 to 40:60, 90:10 to 40:60, 85:15 to 50:50, or 83:17 to 50:50. When injected at this weight ratio, a coating layer of an appropriate content can be formed with an appropriate thickness, the decrease in ionic conductivity of the solid electrolyte can be minimized, and the degree of decrease in ionic conductivity due to exposure to the atmosphere can be lowered, thereby improving atmospheric stability.

The vapor deposition may be a type of vacuum deposition. During the coating process, it is necessary to prevent the solid electrolyte particles from being exposed to the atmosphere, and heat treatment in a vacuum atmosphere is essential for the successful deposition of the linear polysiloxane-based hydrophobic polymer. The heat treatment in the vacuum tube may be performed in a vacuum atmosphere or at an atmospheric pressure of 0.1 mmHg or less.

In addition, heat treatment at a constant temperature is required for uniform vapor deposition of the linear polysiloxane-based hydrophobic polymer. The heat treatment can be performed at a temperature range of 150° C. to 400° C., for example, 150° C. to 350° C., or 200° C. to 300° C. By heat treating in the above temperature range, a thin and uniform thickness coating layer can be formed. For example, if the heat treatment temperature is too low, the vapor deposition reaction rate of the polymer may be low, causing the reaction time to be long or the deposition may not be completed, and if the heat treatment temperature is too high, the vapor deposition reaction rate of the polymer may be high, causing the formation of an uneven coating layer.

In addition, an appropriate level of heat treatment time is required for efficient vapor deposition of the linear polysiloxane-based hydrophobic polymer. The heat treatment can be performed for 0.5 to 6 hours, for example, 0.5 to 5 hours, 0.5 to 4 hours, or 0.5 to 3 hours. By performing heat treatment for the above range of time, a thin and uniform coating layer can be effectively formed. For example, if the heat treatment time is too long, the process time will be longer and the cost will increase, and if the heat treatment time is too short, an uneven coating layer may be formed.

### All-Solid-State Rechargeable Battery

In an embodiment, an all-solid-state rechargeable battery including the aforementioned solid electrolyte is provided. The all-solid-state rechargeable battery includes a positive electrode, a negative electrode, and a solid electrolyte layer between the positive electrode and the negative electrode. The solid electrolyte may be included in one or more of the positive electrode, negative electrode, and solid electrolyte layer.

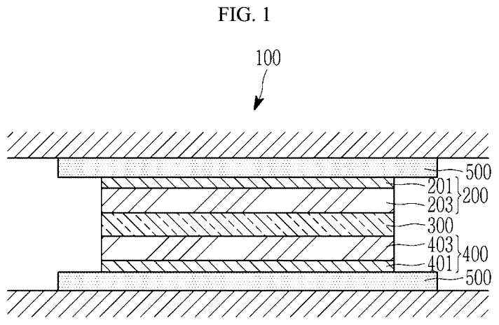

FIG. 1 is a cross-sectional view of an all-solid-state rechargeable battery according to an embodiment. Referring to FIG. 1, the all-solid-state rechargeable battery 100′ may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Solid Electrolyte Layer

The solid electrolyte layer may include the aforementioned solid electrolyte and optionally further include a binder.

The binder may include, for example, a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene propylene copolymer, an ethylene propylene diene copolymer, polyamideimide, polyimide, poly(meth)acrylate, polyacrylonitrile, polystyrene, polyurethane, or a combination thereof.

The solid electrolyte layer may optionally further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsFe, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsFe—, SbFe—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material, may optionally include the aforementioned solid electrolyte.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Here, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

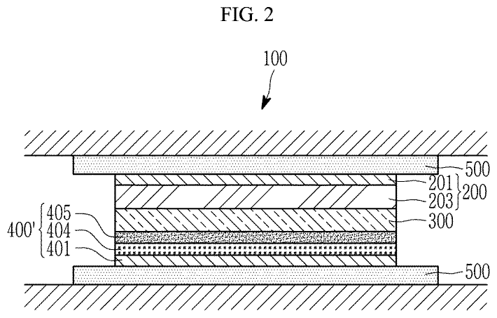

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the aforementioned region or first solid electrolyte layer may be referred to as a surface in contact with the negative electrode coating layer 405.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material. At this time, the positive electrode active material layer may include the solid electrolyte described above.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

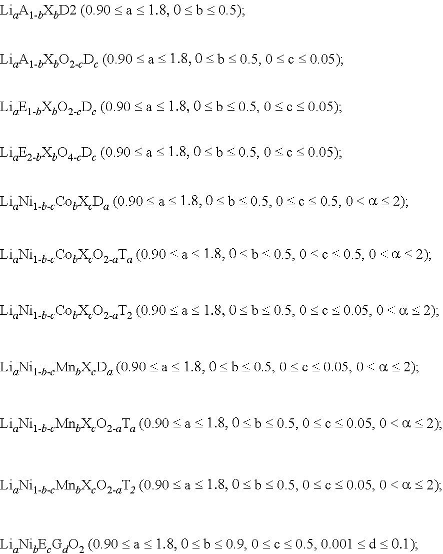

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

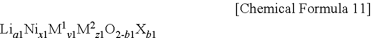

In Chemical Formula 11, 0.9≤a1≤1.8, 0.3≤x1≤1, 0≤y1≤50.7, 0≤z1≤0.7, 0.9≤x1+y1+z1≤51.1, 0≤b≤1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 1, 0.6≤x1≤1, 0≤y1≤0.4, and 0≤z1≤0.4 or 0.8≤x1≤1, 0≤y1≤0.2, and 0≤z1≤0.2.

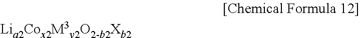

In Chemical Formula 12, 0.9≤a2≤1.8, 0.7≤x2≤1, 0≤y2≤50.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

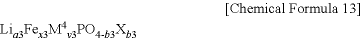

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

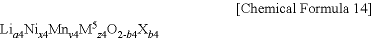

In Chemical Formula 14, 0.9≤a2≤1.8, 0.8≤x4≤1, 0≤y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Here, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Binder

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

The positive electrode current collector may include an aluminum foil, but is not limited thereto.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Preparing of Solid Electrolyte

Argyrodite-type solid electrolyte particles (Li₆PS₅Cl, D50=3.5 μm) and polydimethylsiloxane (PDMS) having a number-average molecular weight of approximately 20,000 g/mol are prepared at a weight ratio of 1:1, and each is placed in an alumina crucible. Each alumina crucible is placed in a glass tube and heat-treated at 243° C. for 1 hour in a vacuum atmosphere of 0.3 mmHg or less to obtain a solid electrolyte according to Example 1.

### Example 2

A solid electrolyte is prepared in substantially the same manner as in Example 1, except that the solid electrolyte particles and PDMS are added in a weight ratio of 5:1.

### Example 3

A solid electrolyte is prepared in substantially the same manner as in Example 1, except that the solid electrolyte particles and PDMS are added in a weight ratio of 10:1.

### Example 4

A solid electrolyte was prepared in substantially the same manner as in Example 1, except that PDMS having a number average molecular weight of about 50,000 g/mol was used.

### Example 5

A solid electrolyte was prepared in substantially the same manner as in Example 4, except that the solid electrolyte particles and PDMS were added in a weight ratio of 5:1.

### Example 6

A solid electrolyte was prepared in substantially the same manner as in Example 4, except that the solid electrolyte particles and PDMS were added in a weight ratio of 10:1.

### Example 7

A solid electrolyte was prepared in substantially the same manner as in Example 1, except that PDMS having a number average molecular weight of about 3,000 g/mol was used.

### Example 8

A solid electrolyte was prepared in substantially the same manner as in Example 7, except that the solid electrolyte particles and PDMS were added in a weight ratio of 5:1.

### Example 9

A solid electrolyte was prepared in substantially the same manner as in Example 7, except that the solid electrolyte particles and PDMS were added at a weight ratio of 10:1.

### Example 10

The PDMS used in Example 1 was dissolved in n-heptane solvent, and then 1H,1H,2H,2H-perfluorodecyltriethoxysilane (PFDTES), a hydrophobic crosslinking agent, and dibutyltin dilaurate (DBTOL), an initiator, were added and stirred at room temperature for 12 hours. At this time, the weight ratio of PDMS/n-heptane/PFDTES/DBTOL is 1/10/0.4/0.005. The prepared solution is dried at room temperature for 12 hours and then at 120° C. for 12 hours to obtain superhydrophobic F-PDMS including fluorine groups.

A solid electrolyte is prepared in substantially the same manner as in Example 1, except that F-PDMS prepared by the above method is used instead of PDMS.

### Example 11

A solid electrolyte is prepared in substantially the same manner as in Example 1, except that halide-based solid electrolyte particles (Li_{2.5}In_{0.5}Zr_{0.5}Cl₆) are used instead of the argyrodite-based solid electrolyte particles.

### Comparative Example 1

Uncoated argyrodite-type solid electrolyte particles (Li₆PS₅Cl, D50=3.5 μm) themselves are used as the solid electrolyte of Comparative Example 1.

### Comparative Example 2

Uncoated halide-based solid electrolyte particles (Li_{2.5}In_{0.5}Zr_{0.5}Cl₆) themselves are used as the solid electrolyte in Comparative Example 2.

### Evaluation Example 1: Cyro-TEM

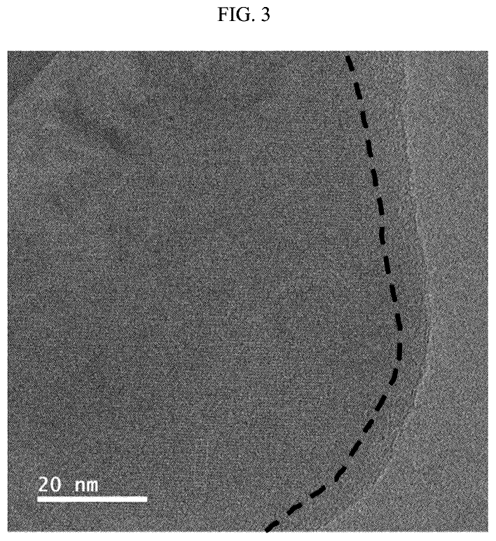

FIG. 3 is a cryogenic transmission electron microscope (Cyro-TEM) image of the solid electrolyte prepared in Example 1. Referring to FIG. 3, an amorphous coating layer of several nm thickness is formed on the surface of the solid electrolyte particles.

### Evaluation Example 2: XPS

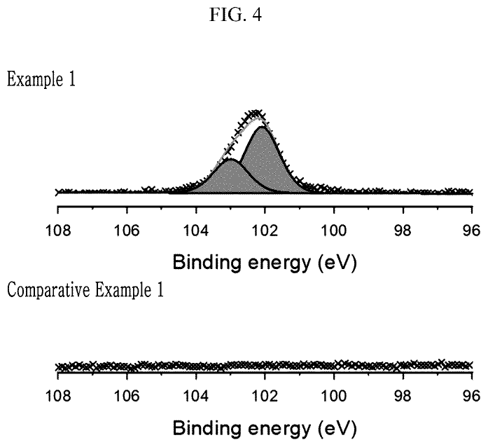

X-ray photoelectron spectroscopy (XPS) analysis was performed on each of the solid electrolytes of Comparative Example 1 before vapor deposition and Example 1 after vapor deposition, and the results are shown in FIG. 4. XPS was performed using a K-Alpha+instrument from Thermo Fisher Scientific using an Al Kα light source under conditions of 12 kV and 6 mA. To avoid exposure to the atmosphere, samples were sampled inside an argon atmosphere glove box and analyzed by transporting the samples to the measuring equipment without exposure to the atmosphere.

Referring to FIG. 4, bonding of the Si 2p region is formed as the hydrophobic polymer PDMS is vapor-deposited. Accordingly, it can be confirmed that the amorphous layer observed in FIG. 3 is a PDMS layer. For reference, the peak position of Si—O bond 2p3/2 is 102±0.1 eV, and the peak position of Si—O bond 2p1/2 is 102.6±0.1 eV.

### Evaluation Example 3: TGA/DTA

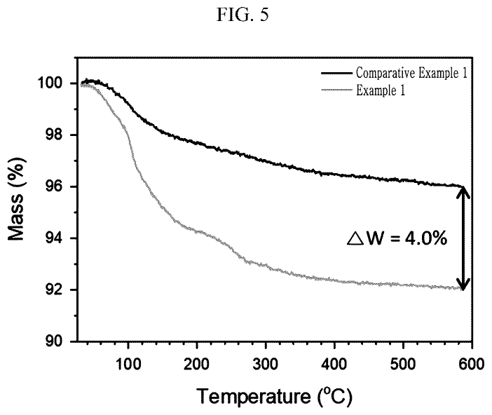

Thermogravimetric analysis (TGA) was performed on each of the solid electrolytes of Comparative Example 1 and Example 1, and the results are shown in FIG. 5. The TGA equipment used was a STA 449 F3 Jupiter Simultaneous Thermal Anaylzer from NETZSCH. About 5 mg of a solid electrolyte sample was placed on an alumina pan and the weight change was measured while the temperature was increased from 30° C. to 600° C. at a rate of 10° C. per minute under an argon atmosphere.

Referring to FIG. 5, the difference in weight between Comparative Example 1 and Example 1 is analyzed to be about 4.0 wt %, which means the weight ratio occupied by the PDMS coating layer in the solid electrolyte of Example 1. That is, in Example 1, the coating layer is understood to be included at about 4.0 wt % based on 100 wt % of the solid electrolyte.

### Evaluation Example 4: EIS

Electrochemical impedance spectroscopy (EIS) analysis was performed on the solid electrolytes of Examples 1 to 9 and Comparative Example 1 before exposure to air and after being stored at a dew point of −50° C. for 24 hours, and the results are shown in Table 1. Iviumstat from IVIUM Technologies Corp. was used as EIS equipment, and analysis was performed from 1 Hz to 7 MHz under voltage conditions of 14.1 mV. The Nyquist plot was obtained by impedance analysis, and the lithium ionic conductivity of the solid electrolyte was calculated from this.

In Table 1, Mn represents the number average molecular weight of PDMS and the unit is g/mol. Ratio refers to the weight ratio of LiPSCl solid electrolyte particles and PDMS. σₚᵣᵢₛ is the ionic conductivity of the solid electrolyte before exposure to air, and σexpo is the ionic conductivity measured after exposing the solid electrolyte to a dew point of −50° C. for 24 hours, and the unit is mS/cm. σₑₓₚₒ/σₚᵣᵢₛ is the ratio of σₑₓₚₒ to σₚᵣᵢₛ multiplied by 100, expressed in %, and a higher value indicates higher atmospheric stability.

TABLE 1

| | Mₙ | Ratio | σₚᵣᵢₛ | σₑₓₚₒ | σₑₓₚₒ/σₚᵣᵢₛ |
|---|---|---|---|---|---|
| Comparative | — | — | 2.5 | 0.91 | 36.1 |
| Example 1 | | | | | |
| Example 1 | ~20,000 | 1:1 | 0.86 | 0.50 | 58.8 |
| Example 2 | | 5:1 | 2.1 | 1.0 | 47.6 |
| Example 3 | | 10:1 | 2.4 | 1.1 | 45.8 |
| Example 4 | ~50,000 | 1:1 | 1.1 | 0.66 | 60.0 |
| Example 5 | | 5:1 | 1.9 | 0.86 | 45.3 |
| Example 6 | | 10:1 | 1.4 | 0.48 | 34.3 |
| Example 7 | ~3,000 | 1:1 | — | — | — |
| Example 8 | | 5:1 | 1.3 | 0.51 | 39.2 |
| Example 9 | | 10:1 | 1.5 | 0.66 | 44.0 |

Referring to Table 1, the solid electrolytes of the examples in which PDMS was vapor-deposited have improved atmospheric stability compared to Comparative Example 1. In particular, in Examples 1 to 3 using a polymer having a number average molecular weight of about 20,000, the effect of improving atmospheric stability by the coating layer is significant, and in Examples 1 and 4 where the solid electrolyte particles and hydrophobic polymer were introduced at a weight ratio of 1:1, the effect of improving atmospheric stability is even higher. Separately, EIS was performed to measure changes in ionic conductivity of the solid electrolytes of Comparative Example 1, Example 1, and Example 10 before exposure to air and after being left under harsh conditions of a dew point of −10° C. for 24 hours, 48 hours, and 72 hours, and the results are shown in Table 2. The units of the values listed in the columns of Pristine, 24 h, 48 h, and 72 h in Table 2 are S/cm, and 72 h/pris is the ratio of 72 h (ionic conductivity after 72 hours) to Pristine (ionic conductivity before exposure to air) multiplied by 100, and the unit is %, and a higher value is interpreted as a higher atmospheric stability.

TABLE 2

| | Pristine | 24 h | 48 h | 72 h | 72 h/pris |
|---|---|---|---|---|---|
| Comparative | 2.52 × | 2.39 × | 6.18 × | 3.78 × | 0.0150 |
| Example 1 | 10⁻³ | 10⁻⁴ | 10⁻⁶ | 10⁻⁷ | |
| (LPSCI) | | | | | |
| Example 1 | 2.27 × | 2.82 × | 5.64 × | 3.99 × | 0.0176 |
| (PDMS-LPSCI) | 10⁻³ | 10⁻⁴ | 10⁻⁶ | 10⁻⁷ | |
| Example 10 (F- | 1.98 × | 2.74 × | 1.03 × | 4.29 × | 0.0217 |
| PDMS-LPSCI) | 10⁻³ | 10⁻⁴ | 10⁻⁵ | 10⁻⁷ | |

Referring to Table 2, the atmospheric stability of Examples 1 and 10 is higher than that of Comparative Example 1. Separately, EIS was performed on the solid electrolytes of Comparative Example 2 and Example 11 using halide-based solid electrolyte particles before exposure to air and after leaving them at a dew point of −50° C. for 24 hours to measure the change in ionic conductivity, and the results are shown in Table 3. The units of σₚᵣᵢₛ and σeₓₚₒ are S/cm, and σₑₓₚₒ/σₚᵣᵢₛ is the ratio of σₑₓₚₒ to σₚᵣᵢₛ multiplied by 100, with the unit being %. A higher value is interpreted as indicating higher atmospheric stability.

TABLE 3

| | σₚᵣᵢₛ | σₑₓₚₒ | σₑₓₚₒ/σₚᵣᵢₛ |
|---|---|---|---|
| Comparative Example 2 | 1.4 × 10⁻³ | 1.3 × 10⁻⁴ | 9.3 |
| (LIZC) | | | |
| Example 11 (PDMS- | 7.0 × 10⁻⁴ | 1.8 × 10⁻⁴ | 25.7 |
| LIZC) | | | |

Referring to Table 3, the solid electrolyte of Example 11 has higher atmospheric stability than that of Comparative Example 2.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

<Description of symbols>

| | |
|---|---|
| 100: all-solid-state battery | 200: positive electrode |
| 201: positive electrode current collector | |
| 203: positive electrode active material layer | |
| 300: solid electrolyte layer | 400: negative electrode |
| 401: negative electrode current collector | |
| 403: negative electrode active material layer | |
| 400′: precipitation-type negative electrode | 404: lithium metal layer |
| 405: negative electrode coating layer | 500: elastic layer |

1. A solid electrolyte, comprising
solid electrolyte particles, and a coating layer on the surface of the solid electrolyte particles,
wherein the coating layer comprises a thermal decomposition product of a linear polysiloxane-based hydrophobic polymer, and
the coating layer has a thickness of 1 nm to 50 nm.

2. The solid electrolyte as claimed in claim 1, wherein
the coating layer is formed by a vapor deposition method.

3. The solid electrolyte as claimed in claim 1, wherein
a thickness of the coating layer is 3 nm to 20 nm.

4. The solid electrolyte as claimed in claim 1, wherein
a variation in the thickness of the coating layer of one solid electrolyte particle is less than or equal to 30%.

5. The solid electrolyte as claimed in claim 1, wherein
a standard deviation of the thickness of the coating layer in one solid electrolyte particle is less than or equal to 5 nm.

6. The solid electrolyte as claimed in claim 1, wherein
the coating layer is included in an amount of 1 to 5 wt % based on 100 wt % of the solid electrolyte.

7. The solid electrolyte as claimed in claim 1, wherein
the linear polysiloxane-based hydrophobic polymer is selected from the group consisting of poly(dimethylsiloxane), poly(methylhydrosiloxane), poly(dimethylsiloxane-co-alkylmethylsiloxane), poly(dimethylsiloxane having a terminal vinyl group), poly(dimethylsiloxane having a terminal bis(hydroxylalkyl) group, poly(dimethylsiloxane) having a terminal bis(3-aminopropyl) group, poly(dimethylsiloxane) having a terminal hydroxyl group, or a combination thereof.

8. The solid electrolyte as claimed in claim 1, wherein
the linear polysiloxane-based hydrophobic polymer comprises a fluorine group.

9. The solid electrolyte as claimed in claim 8, wherein
the linear polysiloxane-based hydrophobic polymer including the fluorine group is selected from 1H,1H,2H,2H-perfluorodecyltriethoxysilane, 1H,1H,2H,2H-perfluorododecyltrichlorosilane, 1H,1H,2H-perfluorooctyltridecoxysilane, or a combination thereof.

10. The solid electrolyte as claimed in claim 1, wherein
the linear polysiloxane-based hydrophobic polymer has a number average molecular weight of 3,000 g/mol to 50,000 g/mol.

11. The solid electrolyte as claimed in claim 1, wherein
the coating layer is amorphous (non-crystalline).

12. The solid electrolyte as claimed in claim 1, wherein
the solid electrolyte particles include a sulfide-based solid electrolyte, an oxide-based solid electrolyte, a halide-based solid electrolyte, or a combination thereof.

13. The solid electrolyte as claimed in claim 1, wherein
an average particle diameter (D50) of the solid electrolyte particles of 0.1 μm to 5.0 μm.

14. A method for preparing a solid electrolyte, comprising
introducing solid electrolyte particles and a linear polysiloxane-based hydrophobic polymer into a vacuum tube without contacting each other, and
heat-treating the vacuum tube to vapor-deposit the linear polysiloxane-based hydrophobic polymer on the surface of the solid electrolyte particles.

15. The method for preparing the solid electrolyte as claimed in claim 14, wherein
the solid electrolyte particles and the linear polysiloxane-based hydrophobic polymer are introduced in a weight ratio of 95:5 to 40:60.

16. The method for preparing the solid electrolyte as claimed in claim 1, wherein
the solid electrolyte particles include a sulfide-based solid electrolyte, an oxide-based solid electrolyte, a halide-based solid electrolyte, or a combination thereof.

17. The method for preparing the solid electrolyte as claimed in claim 14, wherein
the heat-treating is performed at a temperature range of 150° C. to 400° C.

18. The method for preparing the solid electrolyte as claimed in claim 14, wherein
the heat-treating is performed for 0.5 hours to 6 hours.

19. An all-solid-state rechargeable battery comprising the solid electrolyte as claimed in claim 1.
